(19) United States
(12) Patent Application Publication
(10) Pub. No.: US 2010/0320054 A1
(43) Pub. Date: Dec. 23, 2010

(54) LOW RPM, MECHANICAL, ONE-WAY DRIVE, TWO-WAY OVERRUNNING CLUTCH

(76) Inventor: Michael A. D'Eredita, Liverpool, NY (US)

Correspondence Address: BOND, SCHOENECK & KING, PLLC, ONE LINCOLN CENTER, SYRACUSE, NY, 13202-1355, US

(21) Appl. No.: 12/820,786

(22) Filed: Jun. 22, 2010

Related U.S. Application Data
(60) Provisional application No. 61/219,105, filed on Jun. 22, 2009.

(51) Int. Cl. F16D 41/061

(52) U.S. Cl. 192/41 R

(57) ABSTRACT

A clutch assembly including a substantially circular carrier member including a first elongated space formed therethrough, a first bias member including a first end and a second end structured to exert a bias force, and disposed within the first elongated space wherein the first end is connected to the carrier member, and a substantially circular drive cam member coupled to the carrier member including an outside surface, a first seat formed in a portion of the outside surface, and a first drive cam pin connected to the second end of the first bias member within the first elongated space. A clutch assembly including a substantially circular carrier surrounded by at least two drive cam members, and a key member, wherein the key member is at least partially positioned within a first elongated space of the carrier member and connects the first and the second drive cam members is also provided.

### RELATED APPLICATION

The present application claims priority to U.S. provisional patent application No. 61/219,105, filed on Jun. 22, 2009; all of the foregoing patent-related document(s) are hereby incorporated by reference herein in their respective entirety(ies).

### BACKGROUND OF THE INVENTION

1. Field of the Invention

The present invention relates to a mechanical clutch and, more particularly, to a low rotations per minute (rpm), mechanical, one-way drive, two-way overrunning clutch.

2. Description of the Related Art

Currently a number clutches are on the market that allow for the engagement of an outside cylinder by the driving or rotating of a coaxial inside drive shaft. These could be classified as either electromagnetic or mechanical.

Electromagnetic clutches tend to involve the magnetizing of a piece of metal positioned between independent members via a current. The resultant magnetic field effectively engages two otherwise independent members when current is applied to the clutch. Mechanical clutches of this sort tend to rely on “centrifugal forces” whereby driving “dawgs” or “breaking pads” out from the center of the drive shaft and against an outside cylinder.

Centrifugal clutches require the drive shaft to be driven at a relatively high level of rotations per minute before engaging and a higher level in order to increase engagement forces. These clutches also engage in both directions as the “dawgs” or “break pads” expand out from the drive shaft whether it is rotated in one direction or the other.

### SUMMARY OF THE INVENTION

The present invention recognizes that there are potential problems and/or disadvantages with conventional clutches (e.g., centrifugal and electromagnetic). One potential problem/disadvantage is that conventional clutches allow for the engagement of an outside, coaxially aligned cylinder from an input shaft at high RPMs only (i.e., above about 300 rpms). A related problem/disadvantage with the conventional clutches is that these clutches will not allow the engagement of an outside, coaxially aligned cylinder until a degree of rotation of about 360 degrees. Another problem/disadvantage with the conventional clutches is that the force transmitted by these clutches is dependent on rpm. Lastly, in the case of conventional electromagnetic clutches, the forces that an electromagnetic clutch can effectively manage are limited by both the amount of current and quality of material used. This tends to make the costs of these clutches exponentially high relatively to the strength gained. This also requires the inclusion of a power supply to any arrangement involving an electromagnetic clutch (an electrical element in the device that acts to magnetize/demagnetize its engaging elements is required). Various embodiments of the present invention may be advantageous in that they may solve or reduce one or more of the potential problems and/or disadvantages discussed above in this paragraph.

It is therefore a principal object and advantage of the present invention to provide a low rpm, mechanical, one-way drive, two way overrunning clutch that allows for the engagement (“engagement or engaged position”) of an outside, coaxially aligned cylinder from an input shaft in only one direction while allowing for disengagement (“disengagement or disengaged position”) in the opposite direction at a relatively low number of rotations per minute (rpm) (i.e., lower than the rpms when compared to the rpms required to engage a centrifugal clutch as understood by those skilled in the art) while being purely mechanical (i.e., not requiring any electrically generated, magnetized action found in an electromagnetic clutch as understood by those skilled in the art).

It is a further object and advantage of the present invention to provide a low rpm, mechanical, one-way drive, two way overrunning clutch that is structured to go into the engagement position at rpms that are lower than about 300 rpms.

It is another object and advantage of the present invention to provide a low rpm, mechanical, one-way drive, two way overrunning clutch that is structured to provide for the inability of the outside cylinder to engage the drive shaft in the disengagement position, and allow the outside cylinder to overrun in both directions.

It is another object and advantage of the present invention to provide a low rpm, mechanical, one-way drive, two way overrunning clutch that includes an additional carrier component, the action of which is tied directly to a cam via springs that work to bias the clutch assembly into a disengaged position.

It is a further object and advantage of the present invention to provide a low rpm, mechanical, one-way drive, two way overrunning clutch that can go into the engagement position with a range of rotation of 1 to 180 degrees, and more preferably of between 1 to 10 degrees.

It is another object and advantage of the present invention to provide a low rpm, mechanical, one-way drive, two way overrunning clutch that is structured to transmit rotational force that is not dependent on rpms, which allows for a larger range of torque to be transmitted by the clutch as compared with conventional clutches.

It is a further object and advantage of the present invention to provide a low rpm, mechanical, one-way drive, two way overrunning clutch that allows for a more compact design with a more secured and hidden biasing member.

It is another object and advantage of the present invention to provide a low rpm, mechanical, one-way drive, two way overrunning clutch that allows for a less expensive clutch to be developed without losing any necessary accuracy in its construction. This can be achieved by allowing for thinner cam and carrier members (e.g., less than ½ inch) to be stacked in parallel. This allows for common cutting procedures such as laser cutting and water jetting to be used in the manufacturing of the clutch while maintaining the necessary degree of accuracy.

It is a further object and advantage of the present invention to provide a low rpm, mechanical, one-way drive, two way overrunning clutch that allows for numerous configurations that involve various layers of cams and carriers of various dimensions to placed in parallel. This allows for numerous configurations and dimensions to be achieved while maintaining the necessary structural integrity given specific needs and applications (e.g., a smaller outer diameter of the cam can be achieved while allowing for higher amounts of force to be transmitted by increasing the width of the clutch via more layers of cams).

Other objects and advantages of the present invention will in part be obvious, and in part appear hereinafter.

In accordance with the foregoing objects and advantages, an embodiment of the present invention provides a low rpm, mechanical, one-way drive, two way overrunning clutch including, but not limited to: a drive cam with at least one drive cam pin for a biasing member, a carrier with a means for attaching a biasing member, and at least one biasing member attached to the at least one drive cam (an outside cylinder is not part of the clutch, per se). The clutch may also include, but is not limited to, thrust bearing washers, thrust bearings, engagement pins, carrier bearing, drive shaft, carrier disengagement pins, an embedded nest or space for a biasing member, and recoil spring mounts.

In accordance with the foregoing objects and advantages, an alternative embodiment of the present invention provides a low rpm, mechanical, one-way drive, two way overrunning clutch including, but not limited to: parallel drive cams connected to each other in such a way that they form a bridging platform for various types of engagement elements such as engagement pins, a carrier positioned parallel to and between the parallel drive cams, and at least one biasing member. The clutch may also include, but is not limited to, thrust bearing washers, thrust bearings, engagement pins, carrier bearing, drive shaft, carrier disengagement pins, an embedded nest or space for a biasing member, and key.

### BRIEF DESCRIPTION OF THE DRAWINGS

The present invention will be more fully understood and appreciated by reading the following Detailed Description in conjunction with the accompanying drawings, in which:

FIG. 1 is an exploded view of the low rpm, mechanical, one-way drive, two-way overrunning clutch, according to an embodiment of the present invention.

FIG. 2 shows the low rpm, mechanical, one-way drive, two-way overrunning clutch in an engaged position, according to an embodiment of the present invention.

FIG. 3 shows the low rpm, mechanical, one-way drive, two-way overrunning clutch in a disengaged position, according to an embodiment of the present invention.

FIG. 4 is a cross sectional view of the low rpm, mechanical, one-way drive, two-way overrunning clutch without the outside cylinder, according to an embodiment of the present invention.

FIG. 5 is a view of the cam and carrier of the low rpm, mechanical, one-way drive, two-way overrunning clutch where the carrier is sandwiched between two drive cams, according to an alternative embodiment of the present invention.

FIG. 6 shows the low rpm, mechanical, one-way drive, two-way overrunning clutch in a disengaged position where the carrier is sandwiched between two drive cams, according to an alternative embodiment of the present invention.

FIG. 7 shows the low rpm, mechanical, one-way drive, two-way overrunning clutch in an engaged position (cam rotated counterclockwise) where the carrier is sandwiched between two drive cams, according to an alternative embodiment of the present invention.

FIG. 8 is a top view of the low rpm, mechanical, one-way drive, two-way overrunning clutch with 2 cams and carrier where the carrier is sandwiched between two drive cams, according to an alternative embodiment of the present invention.

### DETAILED DESCRIPTION

The present invention will be more fully understood and appreciated by reading the following Detailed Description in conjunction with the accompanying drawings, wherein like reference numerals refer to like components.

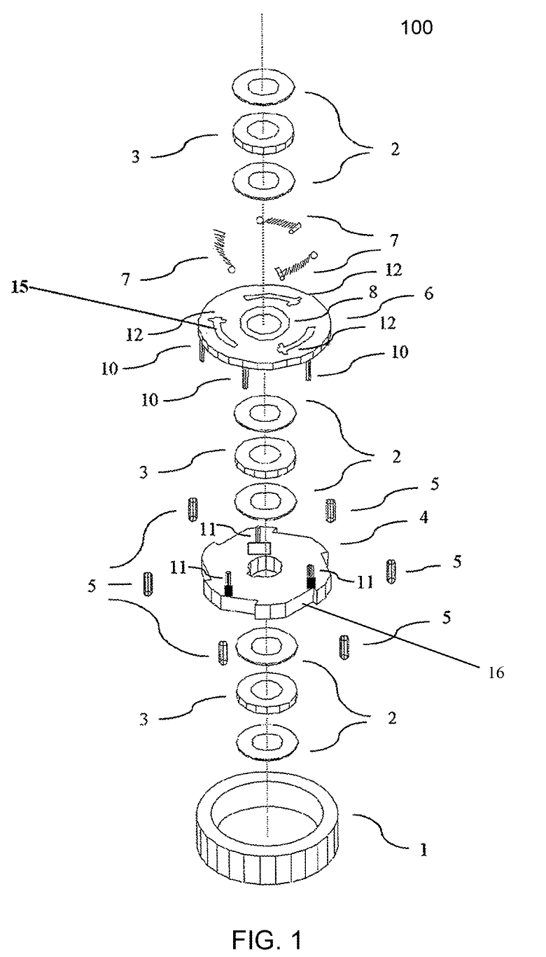

FIG. 1 is an exploded view of the low rpm, mechanical, one-way drive, two-way overrunning clutch, according to an embodiment of the present invention. The clutch 100 may include, but is not limited to, an outside cylinder 1 (included only for purposes of illustrating how said clutch could be integrated, but not considered part of the clutch per se), thrust bearing washers 2, thrust bearings 3, drive cam 4, engagement pins 5, carrier 6, recoil springs 7, carrier bearing 8, drive shaft 9 (not shown), carrier disengagement pins 10, drive cam pins for springs 11, recoil spring mounts 12, a space or nest 15 for the recoil springs 7 in the carrier 6, and a seat 16.

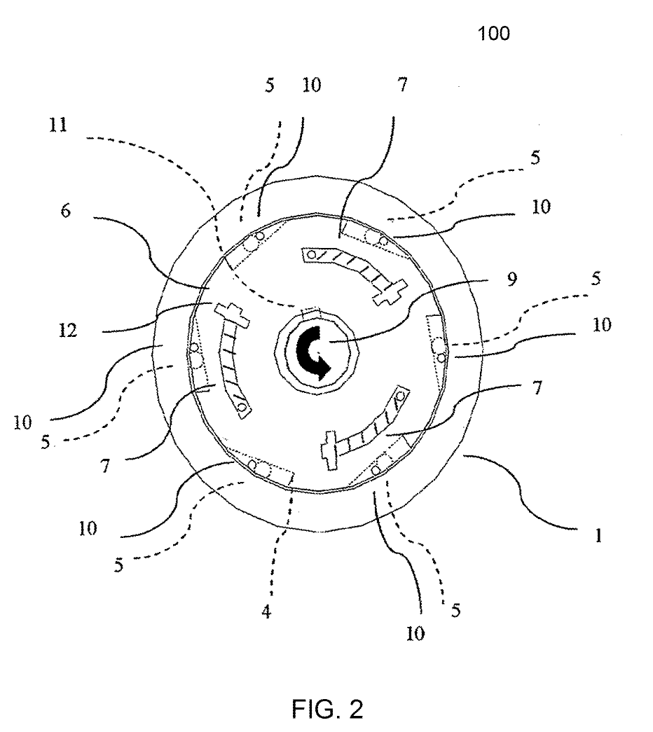

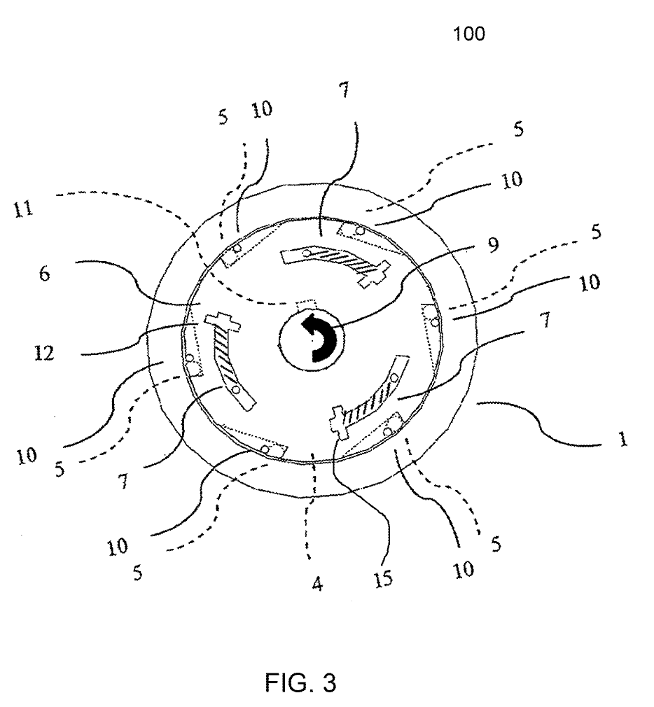

The Drive Shaft 9 and Drive Cam 4 can be anchored to each other (e.g., as a single piece, via a key, etc.). The Drive Cam 4 is structured to perform as an overrunning clutch (as appreciated by those skilled in the art). The Drive Cam 4 is positioned inside the Outside Cylinder 1 such that when rotated in one direction the Engagement Pins 5 wedge between the Drive Cam 4 and Outside Cylinder 1 thus engaging the Drive Shaft 9 directly to the Outside Cylinder 1 via the Drive Cam 4 and Engagement Pins 5 (see FIG. 2, showing the “engagement position”). This is achieved because of the distance between the of the Engagement Pins 5 and Outside Cylinder 1 is such that it is only in contact with the Engagement Pins 5 when they are rolled up the “ramp” (seat 16—which may be tapered) on the Drive Cam 4 as shown by viewing FIG. 3 (disengaged position) to FIG. 2 (engaged position). Otherwise, they are allowed to “float” freely between the Drive Cam 4 and the Outside Cylinder 1.

The Carrier 6 is shown mounted on the Drive Shaft 9 such that is it parallel and next to the Drive Cam 4, separated only by Thrust Bearing Washers 2 and a Thrust Bearing 3. The carrier 6 is allowed to “float” or “free spin” on the Drive Shaft 9 and can be mounted either through a “loose fit” (e.g., a slip fit or larger as appreciated by those skilled in the art) or a friction reducing device such as the roller bearing shown in FIGS. 1, 2 and 3. This bearing or point of interface is labeled as the Carrier Bearing 8.

The Carrier 6 functions to either disengage the Engagement Pins 5 or to keep them from being engaged by the Outside Cylinder 1 via the Carrier Disengagement Pins 10. The Carrier Disengagement Pins 10 are sized such that they extend across the Engagement Pins 5 while still being mounted to the Carrier 6. This function is achieved because the Drive Cam 4 is connected to the Carrier 6 via the Recoil Springs 7 that are anchored to the Drive Cam Pins for Springs 11 and Recoil Spring Mounts 12.

FIG. 2 shows the low rpm, mechanical, one-way drive, two-way overrunning clutch in an engaged position, according to an embodiment of the present invention. As shown in FIG. 2, when the Drive Shaft 9 is rotated in the appropriate axial direction, the Drive Cam 4 wedges the Engagement Pins 5 in place as described above. Due to the inertial forces associated with the Carrier 6, the Drive Cam 4 rotates relative to the Carrier 6 and extends or tensions the Recoil Springs 7. Because of the force exerted on the Drive Shaft 9 the Recoil Springs 7 are unable to recoil, thus leaving the clutch in the engaged position.

FIG. 3 shows the low rpm, mechanical, one-way drive, two-way overrunning clutch in a disengaged position, according to an embodiment of the present invention. As shown in FIG. 3, when the force is reduced on the Drive Shaft 9, the Carrier 6 rotates back to its original position relative to the Drive Cam 4 (as assisted by the recoil of the extension recoil springs 7), thus positioning the Engagement Pins 5 in a position that does not allow the Outside Cylinder 1 to engage them. In this position, the outside cylinder is allowed to overrun in both directions.

The structure of the clutch, as described supra, allows for the clutch of an embodiment of the present invention to be infinitely adjustable depending on the application. That is, the relationship between mass of the Carrier 6 (thus its inertial forces) and the force exerted by the Recoil Springs 7 (e.g. by changing the springs, changing the number of springs, etc.) can be adjusted such that engagement and disengagement meets the needs of a particular application. Also, due to the relative relationships of the Carrier 6 and Drive Cam 4, and the recoil springs 7 embedded in a space 15 in the carrier 6, the clutch is able to be manufactured to meet the optimal width and diameter for any given application (e.g., given torque requirements of a system), while maintaining the inventive aspects of an embodiment of the present invention.

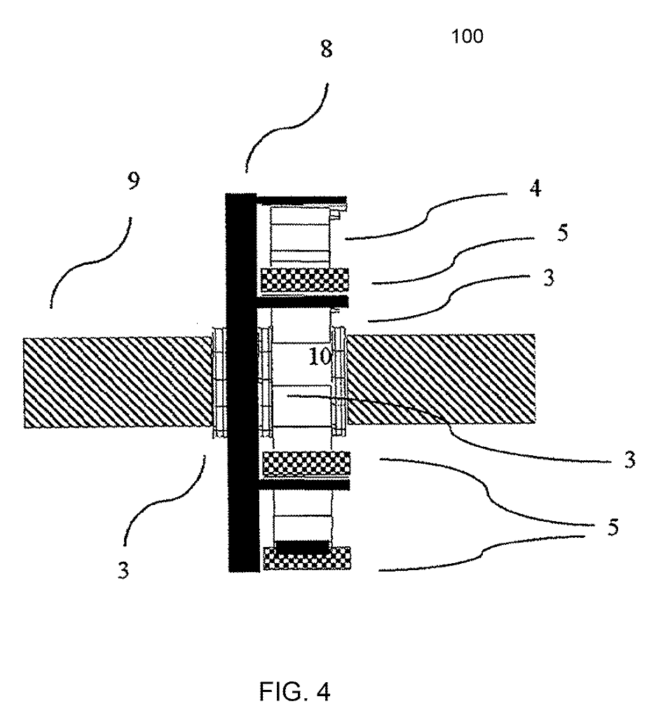

FIG. 4 is a cross sectional view of the low rpm, mechanical, one-way drive, two-way overrunning clutch without the outside cylinder, according to an embodiment of the present invention.

Thus, according to an embodiment of the present invention and as shown and in FIGS. 1-4, the drive cam 4 and carrier 6 are tensioned by the recoil springs 7 such that the carrier 6 holds the engagement pins 5 in a disengaged position until the drive cam 4 is driven by rotating the drive shaft 9, thus causing the drive cam 4 to rotate at a rate that is higher than the recoil springs 7 can keep up with given the inertia of the carrier 6. This effectively “opens” the drive cam 4 and carrier 6, thus exposing the engagement pins 5 to the outside cylinder 1. The engagement pins 5 then “ride up the ramp” (seat 16) on the drive cam 4, wedge between the drive cam 4 and the outside cylinder 1, thus effectively connecting the drive shaft 9 to the outside cylinder 1 via the drive cam 4 and the engagement pins 5. When pressure is released on the drive shaft 9, or the outside cylinder 1 overruns the drive cam 4, the tensioned carrier 6 works to push the engagement pins 5 back into a disengaged position, thus not allowing the outside cylinder 1 to engage the drive cam 4, and thus the drive shaft 9. This effectively creates a scenario where the drive shaft 9 can only engage the outside cylinder 1 in one direction, with the outside cylinder 1 never able to initiate the engagement of the drive cam 4. The above-described relationship of the carrier 6 to the drive cam 4 does not allow the outside cylinder 1 to engage the drive shaft 9 in the neutral position. Thus, one-way driven (by the drive shaft 9), two-way overrunning (by the outside cylinder 1).

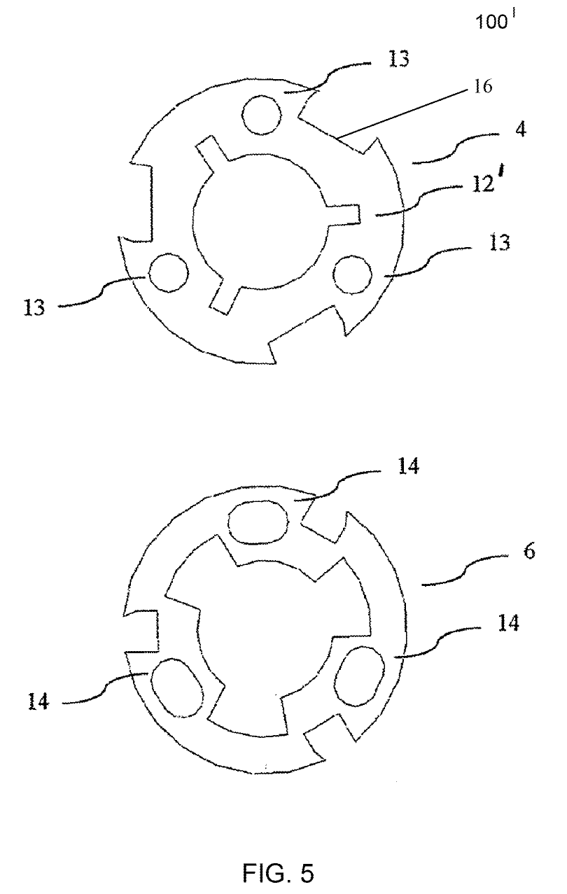

FIGS. 5-8 show an alternative embodiment of the present invention. These figures show a low rpm, mechanical, one-way drive, two-way overrunning clutch where the carrier is sandwiched between two drive cams. The clutch 100′ may include, but is not limited to, outside cylinder 1 (included only for purposes of illustrating how said clutch could be integrated, but not considered part of the clutch per se), thrust bearing washers 2, thrust bearings 3, drive cam (2 in full assembly, but could include more) 4, engagement pins 5, carrier 6 (dashed lines, floats between 2 drive cams), recoil springs 7, carrier bearing 8, drive shaft 9, carrier disengagement pins 10, key(s) 11, keyway(s) 12, pins that join two drive cams 13, carrier clearance holes for mounting pins 14, a space or nest 15 for holding the recoil springs 7, and seat 16.

FIG. 5 is a view of the cam and carrier of the low rpm, mechanical, one-way drive, two-way overrunning clutch where the carrier is sandwiched between two drive cams, according to an alternative embodiment of the present invention. The drive cam (2 in full assembly) 4 is configured to allow the same ramping action of the engagement pins 5, as discussed above with respect to FIGS. 1-4, while allowing for multiple drive cams 4 to be anchored to each other. The current figure is an example of a cam that can be anchored by pins that join multiple cams 13. The carrier 6 is configured to be positioned between multiple drive cams 4 in such a way that it is allowed to move freely, as discussed supra, given how the drive cams 4 are anchored. The current embodiment illustrates a carrier 6 with carrier clearance holes for mounting pins 14 that allow for pins that join two drive cams 13 to connect the cams without interfering with said carrier 6.

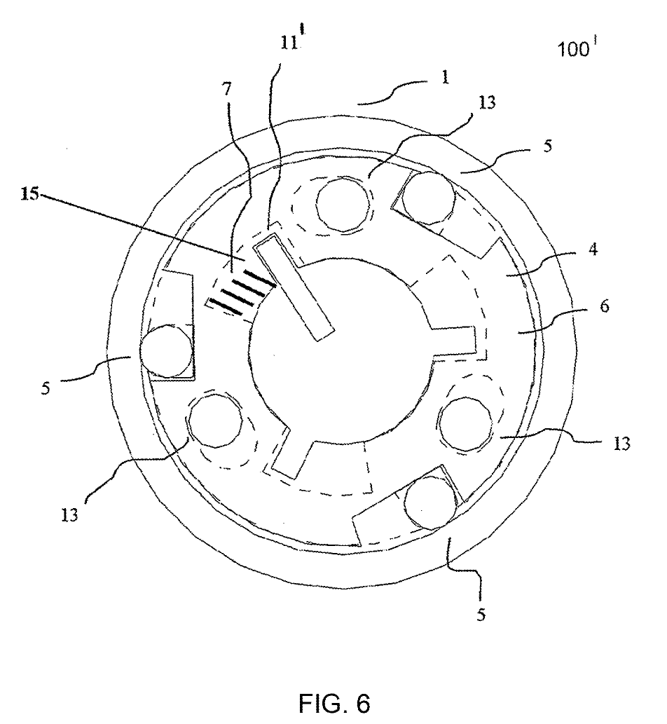

FIG. 6 shows the low rpm, mechanical, one-way drive, two-way overrunning clutch in a disengaged position where the carrier is sandwiched between two drive cams, according to an alternative embodiment of the present invention. As shown, the drive cams 4 are anchored to each other via pins that join two drive cams 13 with the carrier 6 sandwiched between the two drive cams 4. This configuration results in a space for the spring 7.

Similar to FIG. 3 supra, the drive cams 4 and carrier 6 are in the biased position as a result of the spring 7 exerting a force on both the carrier 6 and key 11 which bridges across the two drive cams 4 in such a way that it allows for a direct interface between the drive cams 4, carrier 6 and spring 7 (in this case, a compression spring).

Key 11 also acts as means of anchoring the drive cams 4 to the drive shaft 9 (not shown).

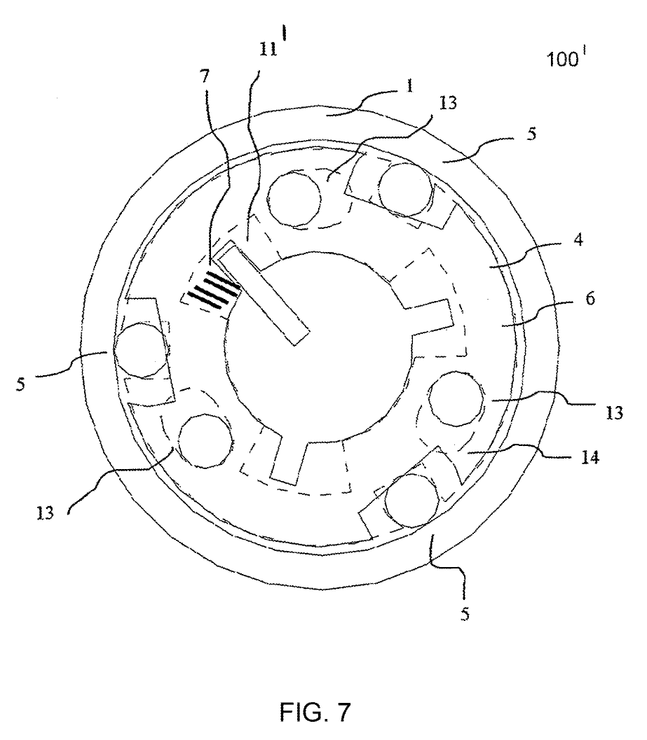

FIG. 7 shows the low rpm, mechanical, one-way drive, two-way overrunning clutch in an engaged position (cam rotated counterclockwise) where the carrier is sandwiched between two drive cams, according to an alternative embodiment of the present invention. Similar to FIG. 2 supra, the drive cams 4 are rotated as to fix the engagement pins 5 between the drive cams 4 and outside cylinder 1 while the carrier 6 remains close to or in its initial position. The momentum of the drive cams 4 and inertial forces of carrier 6 work to compress the spring 7. This leaves the clutch in an engaged positioned until force on drive shaft 9 is reduced as discussed supra.

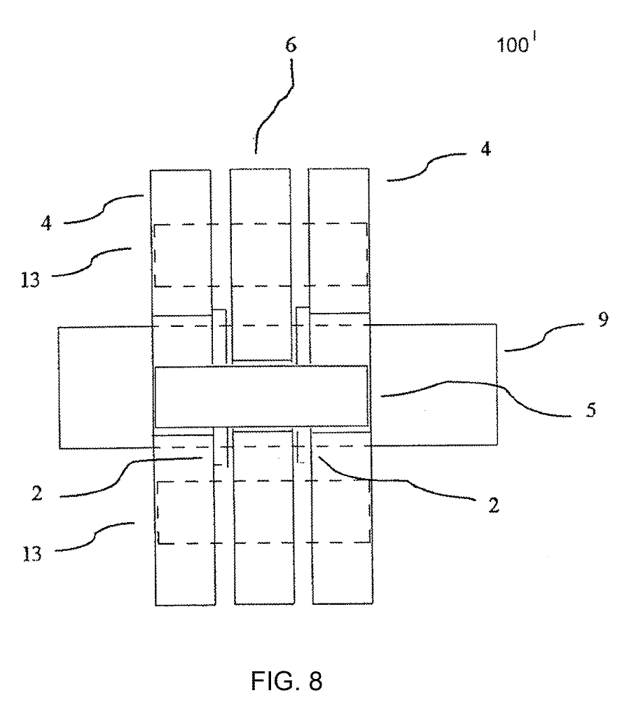

FIG. 8 is a top view of the low rpm, mechanical, one-way drive, two-way overrunning clutch with 2 cams and carrier where the carrier is sandwiched between two drive cams, according to an alternative embodiment of the present invention. This view illustrates the parallel relationship among the drive cams 4 and carrier 6.

Also illustrated is how the drive cams 4 and engagement pins 5 form a bridge when the clutch is assembled.

Also illustrated is how the thrust bearing washers 2 and thrust bearings 3 (not shown) can be arranged as to reduce the frictional forces between the drive cams 4 and carrier 6.

Note that thrust bearings 3 (while not required) allow for the relative ease of assembly of the clutch by enabling one to stack and align all of the elements before fully installing the pins that join two drive cams 13.

In accordance with an alternative embodiment of the present invention, the Outside Cylinder 1 (not shown) can be positioned such that it is mounted on the Drive Shaft 9 via, for example, a bearing arrangement. This allows for a durable arrangement and a higher probability that alignment of all the elements discussed above can be achieve.

Applications of the clutch of an embodiment of the present invention include, but are not limited to, rowing machines, windmills, fishing reels, bicycles, etc (i.e., anything that may require or work with a one-way engagement and two-way overrunning function). While it can be used at low rpms, high rpms may also be appropriate. Thus, embodiments of the present invention allow for the one-way, low rotations per minute driving characteristic of the electromagnetic clutch (albeit with the potential for much higher torque values to be obtained at a relatively low cost) with the mechanical nature of the centrifugal clutches (albeit absent any need for a high level of rotations per minute), and the inability of an outside cylinder to drive an inner drive shaft that both of the conventional clutch types allow for.

As discussed herein, embodiments of the present invention allow for the engagement of an outside cylinder by an inside drive shaft in only one direction via purely mechanical means that do not require a relatively high level of rotations per minute, and allow for relatively high levels of torque to be maintained at relatively low levels of rotations per minute. The engagement of the clutch of an embodiment of the present invention, while presented here are relying on the momentum/inertia relationship of the carrier relative to the drive cam, can also be accomplished by applying a mechanism that effectively holds the carrier in place until the clutch is engaged, thus not relying on the momentum of the drive cam relative to the inertia of the carrier to engage the clutch. This mechanism does not change the characteristic of the clutch, and the relation of carrier to drive cam remains as presented here. It simply allows for a more reliable engagement when the drive shaft is not driven with enough “impulse.” The “mechanism” can be composed of spring(s). One end can be attached to the drive cam, the other to the carrier. It creates the counter-rotational tension between these two members (extension springs are shown, but an arrangement that uses either compression or torsion springs is contemplated by an embodiment of the present invention).

While the invention is susceptible to various modifications, and alternative forms, specific examples thereof have been shown in the drawing and are herein described in detail. It should be understood, however, that the invention is not to be limited to the particular forms or methods disclosed, but to the contrary, the invention is to cover all modifications, equivalents and alternatives falling within the spirit and scope of the present invention.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

Mechanically connected or connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, force fit connections, friction fit connections, connections secured by engagement added by gravitational forces, quick-release connections, pivoting or rotatable connections, slidable mechanical connections, latches and/or magnetic connections).

First, second, third, etc. (“ordinals”): Unless otherwise noted, ordinals only serve to distinguish or identify (e.g., various members of a group); the mere use of ordinals implies neither a consecutive numerical limit nor a serial limitation.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A clutch assembly comprising:
a. a substantially circular carrier member comprising a first elongated space formed therethrough;
b. a first bias member comprising a first end and a second end structured to exert a bias force, and disposed within said first elongated space wherein said first end is connected to said carrier member; and
c. a substantially circular drive cam member coupled to said carrier member comprising an outside surface, a first seat formed in a portion of the outside surface, and a first drive cam pin connected to said second end of said first bias member within said first elongated space.

2. The clutch assembly of claim 1, further comprising an outside cylinder coaxially aligned around said carrier member and said drive cam member.

3. The clutch assembly of claim 2, further comprising a first engagement pin disposed within said first seat.

4. The clutch assembly of claim 3, further comprising an input shaft connected to the drive cam member.

5. The clutch assembly of claim 4, wherein when a force is applied by said input shaft on said drive cam member in a first axial direction said first engagement pin is structured to move from a first position to a second position along said first seat, and wherein when said first engagement pin is in the second position said first engagement pin is structured to engage said drive cam member with said outside cylinder.

6. The clutch assembly of claim 5, wherein when said force is applied by said input shaft on said drive cam member in a first axial direction, said first drive cam pin is structured to exert a force greater than said bias force on said first bias member in said first axial direction.

7. The clutch assembly of claim 6, wherein said force on said first bias member is selected from a tension force and a compression force.

8. The clutch assembly of claim 7, wherein when said force on said drive cam member in a first axial direction is not applied by said input shaft, said first bias member is structured to exert said bias force on said drive cam pin in a second axial direction allowing said first engagement pin to move from the second position to the first position along said first seat.

9. The clutch assembly of claim 8, wherein said carrier member comprises a first carrier disengagement pin, which is disposed within said first seat in between said first engagement pin and said outside cylinder, and is structured to prevent said first engagement pin from moving to the second position along said first seat when said input shaft is not applying said force on said drive cam member in a first axial direction.

10. The clutch assembly of claim 8, wherein when said force on said drive cam member in a first axial direction ceases to be applied by said input shaft and said first engagement pin is in the first position along said first seat, said outside cylinder is structured to rotate in either said first axial direction or said second axial direction.

11. The clutch assembly of claim 8, wherein said first seat is tapered.

12. The clutch assembly of claim 8, further comprising:
a. a second elongated space formed through said carrier member;
b. a second bias member comprising a first end and a second end structured to exert a bias force, and disposed within said second elongated space wherein said first end of said second bias member is connected to said carrier member;
c. a second seat formed in a portion of the outside surface of the drive cam member,
d. a second drive cam pin connected to said drive cam member and said second end of said second bias member within said second elongated space; and
e. a second engagement pin disposed within said second seat.

13. A clutch assembly comprising:
a. a first substantially circular drive cam member comprising an outside surface, wherein a first seat is formed in a portion of the outside surface of said first substantially circular drive cam member;
b. a second substantially circular drive cam member comprising an outside surface, wherein a first seat formed in a portion of the outside surface of said second substantially circular drive cam member;
c. a substantially circular carrier member positioned between said first and second drive cam members and comprising a first elongated space formed therethrough;
d. a first bias member comprising a first end and a second end structured to exert a bias force, and disposed within said first elongated space wherein said first end is connected to said carrier member; and
e. a key member, wherein said key member is at least partially positioned within said first elongated space of said carrier member and connects said first and said second drive cam members.

14. The clutch assembly of claim 13, further comprising an outside cylinder coaxially aligned around said carrier member and said first and second drive cam members.

15. The clutch assembly of claim 14, further comprising a first engagement pin disposed within said first seat of said first drive cam member and within said first seat of said second drive cam member.

16. The clutch assembly of claim 15, wherein when a force is applied on said first and said second drive cam members in a first axial direction said first engagement pin is structured to move from a first position to a second position along said first seat of said first drive cam member and said first seat of said second drive cam member, and wherein when said first engagement pin is in the second position said first engagement pin is structured to engage said first and said second drive cam members with said outside cylinder.

17. The clutch assembly of claim 16, wherein when said force is applied on said first and second drive cam members in a first axial direction, said key member is structured to exert a force greater than said bias force on said first bias member in said first axial direction.

18. The clutch assembly of claim 17, wherein said force on said first bias member is selected from a tension force and a compression force.

19. The clutch assembly of claim 18, wherein when said force on said first and said second drive cam members in a first axial direction is not applied, said first bias member is structured to exert said bias force on said key member in a second axial direction allowing said first engagement pin to move from the second position to the first position along said first seat of said first drive cam member and said first seat of said second drive cam member.

20. The clutch assembly of claim 19, wherein when said force on said first and said second drive cam members in a first axial direction ceases to be applied and said first engagement pin is in the first position along said first seat of said first drive cam member and said first seat of said second drive cam member, said outside cylinder is structured to rotate in either said first axial direction or said second axial direction.
